(19) United States
(12) Patent Application Publication
(10) Pub. No.: US 2007/0277919 A1
(43) Pub. Date: Dec. 6, 2007

(54) SYSTEMS AND METHODS FOR MONITORING AUTOMATED COMPOSITE MANUFACTURING PROCESSES

(75) Inventors: Andrej M. Savol, Sumner, WA (US); Steven R. Walton, Buckley, WA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/383,681

(22) Filed: May 16, 2006

(51) Int. Cl. B32B 37/00; G05G 15/00; B44C 7/00

(52) U.S. Cl. 156/64; 156/352; 156/577

(57) ABSTRACT

Systems and methods for monitoring automated composite fabrication processes are disclosed. In one embodiment, a method includes performing a manufacturing operation on a portion of a workpiece using a tool moveable relative to the workpiece. Simultaneously with performing the manufacturing operation, the tool is translated relative to the workpiece, and a portion of the workpiece upon which the tool has performed the manufacturing operation is monitored. The monitoring includes illuminating an illuminated strip of the workpiece using a laser, and receiving a reflected beam reflected from the illuminated strip into a camera. Output signals from the camera may be analyzed to detect and characterize a feature of interest, wherein the feature of interest may include an edge, an overlap, a gap, a wrinkle, and foreign object debris (FOD).

### FIELD OF THE INVENTION

This invention relates to systems and methods for monitoring automated composite fabrication processes, and more specifically, to systems and methods for monitoring automated, multi-head composite tape placement machines and the like.

### BACKGROUND OF THE INVENTION

Composite structures may be manufactured by progressively building up the structure with a plurality of layers of thin composite tape (or tow) laid one layer upon another. Typically, the operation begins by laying one or more tapes onto a tool or mandrel that has a configuration generally corresponding to the desired shape of the article to be produced. A tape placement head of a manufacturing system controllably moves over the surface of the tool, guiding and applying one or more tapes of composite material onto the tool. The head usually makes repeated passes over the tool in a defined pattern until the composite material is entirely collated, building up successive layers of the composite tape to form the desired workpiece. A compaction roller is typically used for pressing the tape against the workpiece, thereby facilitating adhesion of the successive layers. The workpiece may then be subjected to a curing process (e.g. heating) to further adhere and bond the composite layers. Conventional systems for forming composite structures using successive layers of tape include those systems disclosed, for example, in U.S. Pat. No. 6,799,619 B2 issued to Holmes et al., and U.S. Pat. No. 6,871,684 B2 issued to Engelbart et al.

Although desirable results have been achieved using such prior art systems, there may be room for improvement. For example, inspections to ensure the quality of the composite components manufactured using the above-described systems may require downtime which reduces the production rate and efficiency, and increases the overall cost, of the manufacturing process. Novel systems and methods which reduce or eliminate the downtime associated with monitoring and inspection during the manufacture of composite components would therefore have utility.

### SUMMARY OF THE INVENTION

The present invention is directed to systems and methods for monitoring automated composite fabrication processes. Embodiments of systems and methods in accordance with the present invention may advantageously perform in-process monitoring during automated composite fabrication processes, provide improved detection and characterization of manufacturing defects, and reduce downtime and associated costs in comparison with the prior art.

In one embodiment, a method includes performing a manufacturing operation on a portion of a workpiece using a tool moveable relative to the workpiece. Simultaneously with performing the manufacturing operation, the tool is translated relative to the workpiece, and a portion of the workpiece upon which the tool has performed the manufacturing operation is monitored. The monitoring includes illuminating an illuminated strip of the workpiece using a laser, and receiving a reflected beam reflected from the illuminated strip into a camera. Output signals from the camera may be analyzed to detect and characterize a feature of interest, wherein the feature of interest may include an edge, an overlap, a gap, a wrinkle, and foreign object debris (FOD).

### BRIEF DESCRIPTION OF THE DRAWINGS

Embodiments of the present invention are described in detail below with reference to the following drawings.

FIG. 1 is an isometric view of a system for manufacturing composite components in accordance with an embodiment of the invention;

FIG. 2 is an enlarged, side view of a head assembly of the manufacturing system of FIG. 1 in accordance with an embodiment of the invention;

FIG. 3 is an enlarged, isometric view of a monitoring unit of the head assembly of FIG. 2;

FIG. 4 is a side cross-sectional view of the monitoring unit of FIG. 3 in accordance with an embodiment of the invention;

FIG. 5 is a top view of the monitoring unit of FIG. 4;

FIG. 6 is a flowchart showing a method of performing manufacturing operations in accordance with an embodiment of the invention;

FIG. 7 is a schematic representation of output from the monitoring unit of FIGS. 4 and 5 in accordance with an embodiment of the invention; and

FIG. 8 is a display of actual monitoring data provided by the monitoring unit of FIGS. 4 and 5 in accordance with an embodiment of the invention.

### DETAILED DESCRIPTION

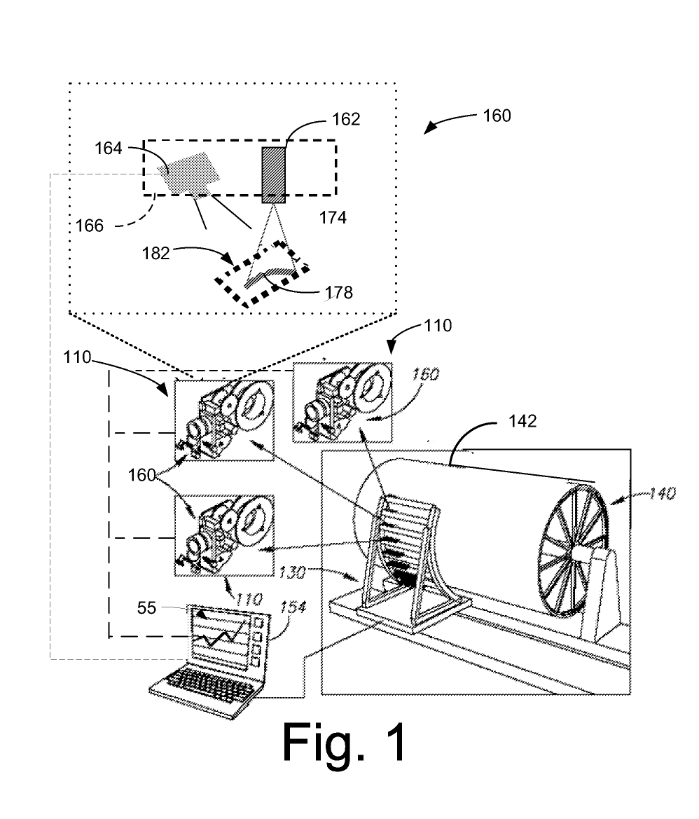

The present invention relates to systems and methods for monitoring automated composite fabrication processes. Many specific details of certain embodiments of the invention are set forth in the following description and in FIGS. 1 through 8 to provide a thorough understanding of such embodiments. One skilled in the art, however, will understand that the present invention may have additional embodiments, or that the present invention may be practiced without several of the details described in the following description.

Generally, embodiments of systems and methods in accordance with the present invention provide a laser-scanning monitoring unit operatively coupled with a head assembly that is configured to perform a desired manufacturing operation, such as applying a fiber-reinforced composite tape onto a tool to form a composite laminate workpiece. The laser-scanning monitoring unit advantageously moves with the head assembly and performs monitoring during the performance of the manufacturing operation by the head assembly. Thus, embodiments of the invention may advantageously reduce the labor and expense associated with monitoring and inspecting during manufacturing operations, and may provide improved detection and characterization of various features of interest, including composite tape edges, gaps and overlaps between successive courses of composite tape, tape wrinkles, and foreign object debris (FOD). Overall, embodiments of the invention may improve production rates and efficiencies, and reduce manufacturing costs, in comparison with prior art systems and methods.

FIG. 1 is an isometric view of a system 100 for manufacturing composite components in accordance with an embodiment of the invention. In this embodiment, the system 100 includes a plurality of head assemblies 110 coupled to a translation platform 130 and operatively positioned proximate a forming tool (or mandrel) 140. The translation platform 130 is configured to systematically move the head assemblies 110 along translation paths (e.g. three-dimensional paths) proximate the forming tool 140, and each head assembly 110 is configured to perform placement and consolidation of a fiber-reinforced composite tape material onto the forming tool 140 to produce a laminated composite workpiece 142, as described more fully below. Each head assembly 110 a monitoring unit 160 configured to perform in-process inspections of the manufacturing processes (in this case, composite tape application processes) performed by the head assembly 110. Structural and operational features of the monitoring unit 160 are described more fully below.

In the embodiment shown in FIG. 1, the system 100 includes a computer (or controller) 154 operatively coupled to the translation platform 130 and to the head assemblies 110. The computer 154 is configured to implement a control code that transmits control signals to the translation platform 130 and the head assemblies 110. The control signals command the movement and functions of the translation platform 130 and the head assemblies 110, thereby causing automated (or semi-automated) manufacturing of the laminated composite workpiece 142 on the forming tool 140. In the embodiment shown in FIG. 1, the manufacturing system 100 is of a type known as a multi-head tape lamination machine (MHTLM). In one specific embodiment, the system 100 includes eight head assemblies 110 for the placement of composite tape, however, in alternate embodiments, any desired number of head assemblies 110 may be employed.

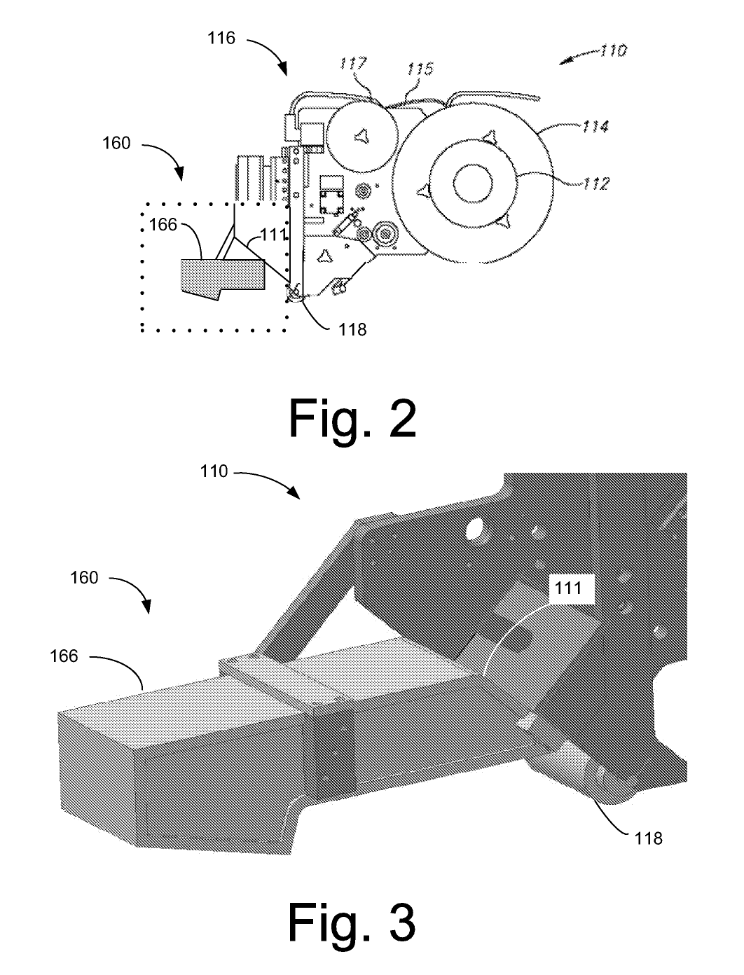

FIG. 2 is an enlarged, side view of the head assembly 110 of the manufacturing system 100 of FIG. 1. In this embodiment, the head assembly 110 includes a spindle 112 configured to retain a roll 114 of a fiber-reinforced composite tape 115, and a feed assembly 116 configured to receive, guide, feed, and apply the tape 115 from the roll 114 onto the workpiece 142. More specifically, the feed assembly 116 includes a feed roller 117 that receives the tape 115 from the roll 114, and a compaction roller 118 that applies and compresses the tape 115 onto the workpiece 142. The feed assembly 116 may include a variety of other components (e.g. motors, rollers, guides, sensors, etc.) configured to cooperatively receive, feed, and guide the tape 115 from the roll 114 to the compaction roller 118, as described more fully, for example, in U.S. Pat. No. 6,799,619 B2 issued to Holmes et al., and U.S. Pat. No. 6,871,684 B2 issued to Engelbart et al., as well as in co-pending, commonly-owned U.S. patent application Ser. Nos. 09/998,478 and 10/644,148, which patents and pending patent applications are incorporated herein by reference.

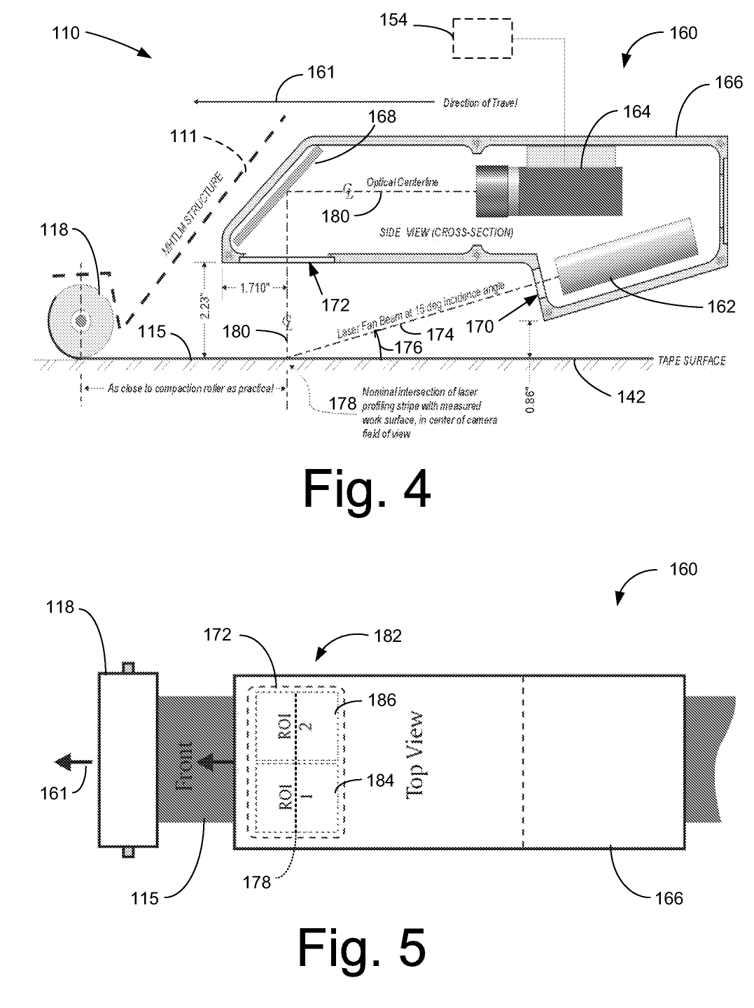

FIG. 3 is an enlarged, isometric view of the monitoring unit 160 of the head assembly 110 of FIG. 2. FIG. 4 is a side cross-sectional view of the monitoring unit 160 of FIG. 3. As best shown in FIG. 3, the monitoring unit 160 includes two side-by-side laser fan-beam projectors 162 and a camera 164 disposed within a housing 166. The housing 166 is coupled to a structural portion 111 of the head assembly 110 proximate to the compaction roller 118, and includes first and second apertures 170, 172. A mirror 168 is positioned within the housing 166 proximate the second aperture 172. In one particular embodiment, the laser fan-beam projectors 162 are Lasiris Model MFL units commercially-available from Stocker Yale of Salem, N.H., USA, and the camera 164 is a Model KP-M22A video camera, commercially-available from Hitachi Kokusai Electric Incorporated of Tokyo, Japan. In alternate embodiments, any suitable laser scanners or cameras may be used.

As best shown in FIG. 4, as the head assembly 110 is traversed over the workpiece 142 in a direction of travel 161, the laser scanners 162 provide fan beams 174 that are projected through the first aperture 170 onto the composite tape 115 after the composite tape 115 has been applied to the workpiece 142 by the compaction roller 118. The fan beams 174 intersect the composite tape 115 at an incidence angle 176, and produce illuminated stripes 178 that extends laterally (or transversely) across the composite tape 115. In one particular embodiment, the incidence angle 176 is approximately 15 degrees, however, in alternate embodiments, incidence angles between approximately 10 degrees and approximately 35 degrees may be used. Alternately, any other suitable incidence angle may be used. As described more fully below, the monitoring unit 160 is configured to detect and characterize various features of interest (e.g. edges, gaps, wrinkles, puckers, overlaps, foreign object debris (FOD), etc.) along the illuminated stripes 178. Preferably, the monitoring unit 160 is positioned such that the illuminated stripes 178 are relatively close (e.g. as close as practical) to the compaction roller 118 so that features of interest may be detected relatively quickly in the manufacturing process.

As further shown in FIG. 4, a reflected beam 180 reflects upwardly from the composite tape 115, passes into the housing 166 through the second aperture 172, and reflects from the mirror 168 to the camera 164. In one particular embodiment, the reflected beam 180 reflects approximately normally from the composite tape 115, however, in alternate embodiments, any other suitable reflection angle may be used. The camera 164 receives the reflected beam 180 and transmits data to the computer 154 for analysis and display.

FIG. 5 is a top view of the monitoring unit 160 of FIG. 4. In this embodiment, a field of view 182 of the camera 164 through the second aperture 172 is divided into first and second regions of interest (ROI) 184, 186, and the illuminated laser stripe 178 of each laser is approximately centered within each ROI field of view 182.

Communication between the monitoring units 160 and the computer 154, or between any of the other various components of the system 100 (e.g. between the computer 154 and the translation platform 130, assembly heads 110, etc.), may be accomplished by standard Ethernet connections, or alternately, by a custom network or server. Communication may also be achieved through a wireless network, including a wireless network that utilizes spread spectrum RF to overcome sources of interference in a typical factory environment.

The computer 154 may be configured to analyze the data provided by the camera 164 to determine whether any features of interest are present, and if so, may characterize such features of interest into various categories including, for example, edges, gaps, wrinkles, overlaps, and various types of FOD. The computer 154 may be further configured to perform various functions based on the results of the detection and characterization of a feature of interest, including displaying the data from the camera 164 via a display 155 (FIG. 1), identifying the feature of interest, notifying an operator, recording information regarding the feature of interest (e.g. location, type, etc.), and if needed, halting manufacturing operations to permit further inspection and remedial action.

More specifically, the computer 154 may receive and maintain a running display of images (both with and without possible features of interest) from the camera 164 of the monitoring unit 160. For multiple head assemblies 110, this may be accomplished by a split screen display that shows the view from each head assembly 110 simultaneously in discrete windows on the display 155. Alternately, the view from each head assembly 110 may be displayed individually through selection of that head assembly 110 from a list by an operator.

To analyze the data provided by the monitoring units 160, the computer 154 may use a variety of suitable methods and algorithms for detecting, analyzing, and characterizing features of interest, and for taking appropriate action based on the results of such analyses. For example, in some embodiments, the computer 154 may be configured to perform one or more of the methods and algorithms disclosed in U.S. Pat. No. 6,871,684 issued to Engelbart et al. on Mar. 29, 2005, as well as those methods and algorithms disclosed in the following co-pending, commonly-owned patent applications, incorporated herein by reference: U.S. patent application Ser. No. 09/819,922 by Engelbart et al. filed on Mar. 28, 2001, U.S. patent application Ser. No. 10/628,691 filed on Jul. 28, 2003, U.S. patent application Ser. No. 10/726,099 by Engelbart et al. filed on Dec. 2, 2003, U.S. patent application Ser. No. 10/946,267 by Engelbart et al. filed on Sep. 21, 2004, U.S. patent application Ser. No. 10/904,727 by Engelbart et al. filed on Nov. 24, 2004, and U.S. patent application Ser. No. 10/904,719 by Engelbart et al. filed on Nov. 24, 2004.

Generally, any of the methods described herein can be implemented using software, firmware (e.g., fixed logic circuitry), hardware, manual processing, or any combination of these implementations. The terms “module,” “functionality,” and “logic” generally represent software, firmware, hardware, or any combination thereof. In the case of a software implementation, the module, functionality, or logic represents program code that performs specified tasks when executed on processor(s) (e.g., any of microprocessors, controllers, and the like). The program code can be stored in one or more computer readable memory devices. Further, the methods and systems described herein are platform-independent such that the techniques may be implemented on a variety of commercial computing platforms having a variety of processors.

Furthermore, one or more of the methods disclosed herein may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices. For example, in alternate embodiments, one or more of the above-noted operations of the computer 154 may be distributed to one or more separate processing units, such as processing units installed within each assembly head 110, or within each monitoring unit 160, or any other suitable arrangement.

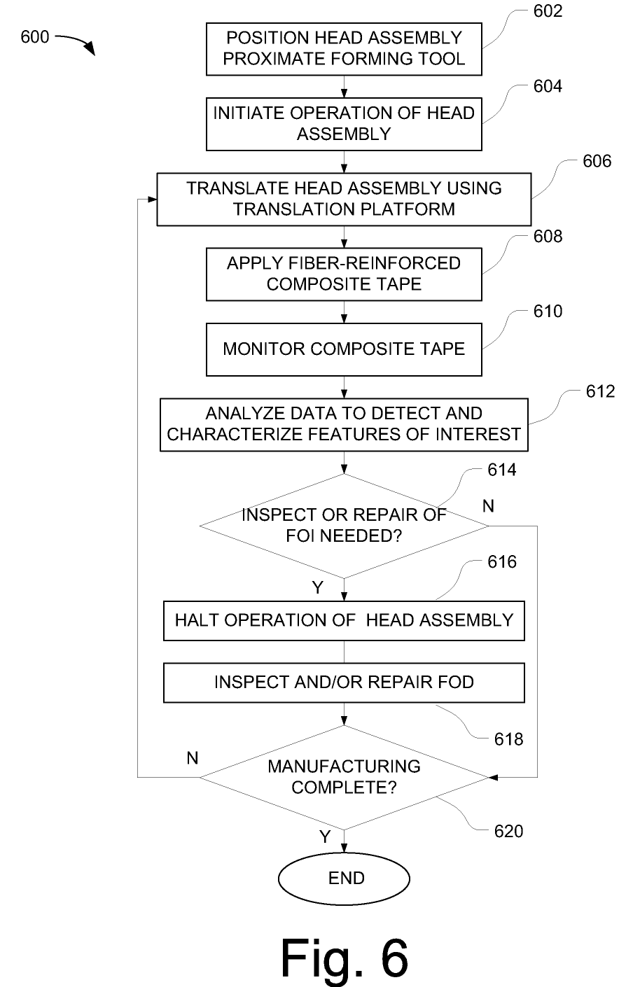

FIG. 6 is a flowchart showing a method 600 of performing manufacturing operations in accordance with an embodiment of the invention. The order in which the method is described is not intended to be construed as a limitation, and any number of the described method blocks can be combined in any order to implement the method, or an alternate method. Furthermore, the method can be implemented in any suitable hardware, software, firmware, or combination thereof.

In this embodiment, the method 600 includes positioning at least one head assembly 110 proximate the forming tool 140 at a block 602, initiating operation of the head assembly 110 at a block 604, and translating the head assembly 110 using the translation platform 130 at a block 606. At a block 608, the fiber-reinforced composite tape 115 is applied, either directly to the forming tool 140 or to the previously-applied layers of the workpiece 142. The application of the composite tape 115 (block 608) preferably occurs simultaneously with the translation of the head assembly 110 (block 606).

At a block 610, the composite tape 115 is monitored (e.g. at a location proximate to the compaction roller 118) by scanning the fan beams 174 onto the composite tape 115, and capturing the reflected beams 180 using the camera 164. The monitoring of the manufacturing operation (block 610) preferably occurs simultaneously with the performance of the manufacturing operation (block 608). In alternate embodiments, however, the monitoring may occur subsequent to the manufacturing operation, such as by performing a follow-up sweep over a portion of composite tape 115 (e.g. a course) using the monitoring unit 160 after each portion has been applied.

As further shown in FIG. 6, at a block 612, the data provided by the monitoring unit 160 are analyzed in an attempt to detect and characterize any features of interest that may be present in the illuminated stripes 178. The analysis of the data from the monitoring unit (block 612) preferably occurs simultaneously with the performance of the monitoring (block 610) during the manufacturing operation (block 608). In alternate embodiments, however, the analysis may occur subsequent to the monitoring, such as by post-processing the data after the monitoring is performed over a portion of composite tape 115.

At a block 614, a determination is made regarding whether a feature of interest that has been detected during the analysis of the data (block 612) merits further inspection or possible remedial action (e.g. repair). If so, then the manufacturing operation (e.g. the operation of the head assembly 110, translation assembly 130, etc.) may be halted at a block 616, and the further inspection, remedial action, or both are performed at a block 618. After the required actions are performed at block 618, or if it is determined at block 614 that the feature of interest does not require further inspection or remedial action, the method 600 determines whether manufacturing operations are complete at a block 620. If manufacturing operations are not complete, then the method 600 returns to block 606 and continues the above-described actions. Alternately, if manufacturing operations are complete, then the method 600 ends or continues to other actions.

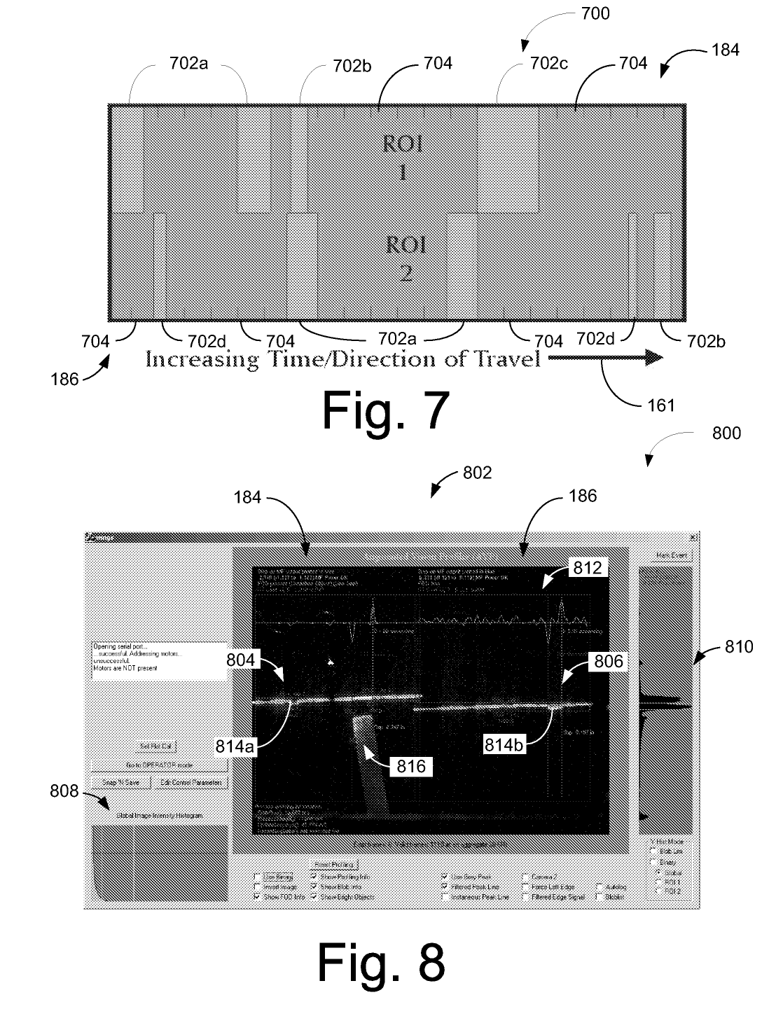

FIG. 7 is a schematic representation of output 700 from the monitoring unit 160 of FIGS. 4 and 5. In this embodiment, data acquired by the camera 164 within the first and second regions of interest 184, 186 are displayed as a function of time (or direction of travel 161) during monitoring of a composite tape application process. In the first and second regions of interest 184, 186, both positive data segments 702 indicating the presence of features of interest, and negative data segments 704 indicating the absence of features of interest, as shown. More specifically, the positive data segments 702 are categorized into different types of positive segments 702a, 702b, 702c, 702d, 702e having different characteristics indicative of different types of features of interest. In the schematic representation shown in FIG. 7, the different types of positive segments 702a-e are represented as having different widths, however, in alternate embodiments, the different types of positive segments 702a-e may be categorized and distinguished using any distinguishing characteristic or set of characteristics, including, for example, intensity, size, spectral diversity, or any other suitable characteristic.

FIG. 8 is a display 800 of actual monitoring data provided by the monitoring unit 160. In this embodiment, the display 800 includes a “real time” view 802 from the camera 164 that includes the first and second regions of interest 184, 186 (FIG. 5). First and second portions 804, 806 of the illuminated strip 178 are displayed within the first and second regions of interest 184, 186, respectively. The first and second portions 804, 806 may be used to detect and characterize features of interest, including edges, gaps, wrinkles, overlaps, and various types of FOD conditions. In addition, the positions of the first and second portions 804, 806 reflect gross height above the mandrel 140, and thus, the thickness of the workpiece 142.

A horizontal plot 812 is the output of a step detector module that analyzes the first and second portions 804, 806 of the illuminated strip 178 and may locate various features of interest, including edges of composite tape 115, and overlaps and gaps between successive courses of composite tape 115. In one embodiment, the step detector module operates upon the difference between a calibrated flat and a center of mass of the portions 804, 806 for each raster column of the image 802. In the display 800 shown in FIG. 8, a gap 814b has been detected in the second region of interest 186, while a gap 814a and a FOD 816 have been detected in the first region of interest 184.

Various other output signals may be displayed, depending on the operating parameters and the desired elements that are selected by the dialog checkboxes seen along the bottom of the display 800. On the lower left of the display 800 is a global image intensity histogram 808, which displays the distribution of image pixel values and the two thresholds that are used in a binarization phase of the image processing. A second histogram 810 is shown on the right side of the display 800, representing a vertical projection of pixel values.

Embodiments of systems and methods in accordance with the present invention may provide significant advantages over the prior art. For example, because the head assembly 110 includes its own dedicated monitoring unit 160 for performing inspections, in-process inspections may be performed simultaneously on different regions of the workpiece 142 as the head assemblies 110 are simultaneously performing manufacturing operations. The monitoring units 160 advantageously reduce downtime of the manufacturing system 100 by reducing or eliminating the need to shift inspection hardware between head assemblies 110. Thus, embodiments of the invention may advantageously reduce the labor and expense associated with monitoring and inspecting during manufacturing operations, and may provide improved detection and characterization of various features of interest, including composite tape edges, gaps and overlaps between successive courses of composite tape, tape wrinkles, and foreign object debris (FOD). Overall, embodiments of the invention may improve production rates and efficiencies, and reduce manufacturing costs, in comparison with prior art systems and methods.

Embodiments of the invention may be used in a wide variety of manufacturing applications for manufacturing a wide variety of components for a wide variety of products. For example, in the manufacturing system 100 shown in FIG. 1, the forming tool 140 is configured for forming an elongated, tubular workpiece 142. In one specific embodiment, the workpiece 142 is a fuselage portion of an airplane, such as the 787 passenger aircraft commercially-available from The Boeing Company of Chicago, Ill. It will be appreciated, however, that alternate embodiments of the invention may be employed for the manufacture of composite components for a variety of other products, including other components for commercial and military aircraft, rotary wing aircraft, missiles or other types of flight vehicles, as well as components for boats, automobiles, trucks and other types of terrestrial vehicles, and any other desired structures.

Furthermore, although the disclosed embodiments have been described as being configured for the application and collation of fiber-reinforced composite tape, it may be appreciated that in alternate embodiments, head assemblies having vision inspection units in accordance with the present invention may be equipped with other types of tools for performing other types of manufacturing operations. For example, in alternate embodiments, assemblies in accordance with the invention may include riveters, welders, wrenches, clamps, sanders, nailers, screw guns, mechanical and electromagnetic dent pullers, and virtually any other desired type of manufacturing tools and measuring instruments.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A head assembly for performing a manufacturing operation on a workpiece, comprising:
a tool moveable relative to the workpiece and configured to perform the manufacturing operation on the workpiece; and
a monitoring unit operatively coupled to and moveable with the tool relative to the workpiece, the monitoring unit including:
a laser configured to illuminate an illuminated strip of the workpiece upon which the tool has performed the manufacturing operation; and
a camera configured to receive a reflected beam reflected from the illuminated strip;
wherein the monitoring unit is further configured to illuminate the illuminated strip and receive the reflected beam simultaneously with the performance of the manufacturing operation using the tool.

2. The head assembly of claim 1, wherein the monitoring unit is further configured to illuminate the illuminated strip using a fan beam emitted from a laser scanner.

3. The head assembly of claim 1, wherein the tool is configured to perform an application of a composite tape onto the workpiece, and wherein the monitoring unit is configured to illuminate an illuminated strip of the composite tape.

4. The head assembly of claim 3, wherein the tool includes:
a spindle configured to support a supply of the composite tape; and
a feed assembly configured to feed the composite tape from the supply to the workpiece, the feed assembly having a rotatable compaction roller configured to apply the composite tape onto the workpiece.

5. The head assembly of claim 4, wherein the monitoring unit is further configured to illuminate the illuminated strip using a fan beam emitted from a laser scanner, and wherein the camera is further configured to transmit signals corresponding to the received reflected beam to a data analysis component.

6. The head assembly of claim 1, wherein an incidence angle of the illuminating beam from the laser is approximately fifteen degrees with respect to the illuminated strip of the workpiece, and a reflection angle of the reflected beam is approximately ninety degrees with respect to the illuminated strip of the workpiece.

7. The head assembly of claim 1, wherein the laser comprises a laser scanner and the illuminating beam comprises a fan beam, and wherein the monitoring unit further includes a housing operatively coupled to the tool, and a mirror disposed within the housing, the camera being disposed within the housing, and the laser scanner being disposed within the housing and configured to transmit the fan beam through a first aperture in the housing, the housing having a second aperture configured to receive the reflected beam, the reflected beam being further reflected by the mirror to the camera.

8. A system for performing a manufacturing operation on a workpiece, comprising:
at least one head assembly configured to perform the manufacturing operation on the workpiece; and
a translation platform coupled to the at least one head assembly, the translation platform being configured to operatively position the head assembly proximate the workpiece and to systematically move the head assembly along a translation path proximate the workpiece, and wherein the head assembly includes:
a tool moveable relative to the workpiece and configured to perform the manufacturing operation on the workpiece; and
a monitoring unit operatively coupled to and moveable with the tool relative to the workpiece, the monitoring unit including:
a laser configured to illuminate an illuminated strip of the workpiece upon which the tool has performed the manufacturing operation; and
a camera configured to receive a reflected beam reflected from the illuminated strip;
wherein the monitoring unit is further configured to illuminate the illuminated strip and receive the reflected beam simultaneously with the performance of the manufacturing operation using the tool.

9. The system of claim 8, wherein the tool is configured to perform an application of a composite tape onto the workpiece, and wherein the monitoring unit is configured to illuminate an illuminated strip of the composite tape.

10. The system of claim 9, wherein the tool includes:
a spindle configured to support a supply of the composite tape; and
a feed assembly configured to feed the composite tape from the supply to the workpiece, the feed assembly having a rotatable compaction roller configured to apply the composite tape onto the workpiece.

11. The system of claim 10, wherein the monitoring unit is further configured to illuminate the illuminated strip using a fan beam emitted from a laser scanner, and wherein the camera is further configured to transmit signals corresponding to the received reflected beam to a data analysis component.

12. The system of claim 8, wherein the laser comprises a laser scanner and the illuminating beam comprises a fan beam, and wherein the monitoring unit further includes a housing operatively coupled to the tool, and a mirror disposed within the housing, the camera being disposed within the housing, and the laser scanner being disposed within the housing and configured to transmit the fan beam through a first aperture in the housing, the housing having a second aperture configured to receive the reflected beam, the reflected beam being further reflected by the mirror to the camera.

13. The system of claim 8, further comprising a computer operatively coupled to the translation platform and to the head assembly, the computer being configured to transmit control signals to the translation platform and to the head assembly to perform at least one of automated and semi-automated manufacturing operations.

14. The system of claim 13, wherein the computer is further configured to receive output signals from the camera indicative of the reflected beam, and to analyze the output signals to at least one of detect and characterize a feature of interest, wherein the feature of interest includes at least one of an edge, an overlap, a gap, a wrinkle, and foreign object debris (FOD).

15. A method of performing a manufacturing operation on a workpiece, comprising:
performing the manufacturing operation on a portion of the workpiece using a tool moveable relative to the workpiece;
simultaneously with performing the manufacturing operation, translating the tool relative to the workpiece; and
simultaneously with performing the manufacturing operation, monitoring a portion of the workpiece upon which the tool has performed the manufacturing operation, wherein the monitoring includes:
illuminating an illuminated strip of the workpiece using a laser; and
receiving a reflected beam reflected from the illuminated strip into a camera.

16. The method of claim 15, wherein performing the manufacturing operation includes applying a composite tape onto the workpiece, and wherein illuminating an illuminated strip includes illuminating an illuminated strip of the composite tape.

17. The method of claim 16, wherein performing the manufacturing operation further includes feeding the composite tape from a tape supply to a compaction roller, and wherein applying the composite tape includes compacting the composite tape onto the workpiece using the compaction roller.

18. The method of claim 15, wherein illuminating the illuminated strip includes illuminating the illuminated strip using a fan beam emitted from a laser scanner, and wherein receiving a reflected beam includes receiving the reflected beam into a camera configured to transmit signals corresponding to the received reflected beam to a data analysis component.

19. The method of claim 18, further comprising receiving the output signals from the camera, and analyzing the output signals to at least one of detect and characterize a feature of interest, wherein the feature of interest includes at least one of an edge, an overlap, a gap, a wrinkle, and a foreign object debris (FOD).

20. The method of claim 18, further comprising:
analyzing the output signals;
detecting a feature of interest;
characterizing the feature of interest;
determining that at least one of inspection and remedial action is required; and
halting the manufacturing operation.
